(19) United States
(12) Patent Application Publication
(10) Pub. No.: US 2023/0230342 A1
(43) Pub. Date: Jul. 20, 2023

(54) TRAINING DATA SELECTION DEVICE, TRAINING DATA SELECTION METHOD, AND PROGRAM

(71) Applicant: Sony Interactive Entertainment Inc., Tokyo (JP)

(72) Inventor: Shogo Sato, Tokyo (JP)

(73) Assignee: Sony Interactive Entertainment Inc., Tokyo (JP)

(21) Appl. No.: 18/001,776

(22) PCT Filed: Jul. 3, 2020
(86) PCT No.: PCT/JP2020/026262

§ 371 Date: Dec. 14, 2022

(51) Int. Cl. G06V 10/44; G06V 10/74; G06V 10/774

(52) U.S. Cl. CPC G06V 10/44; G06V 10/761; G06V 10/774

(57) ABSTRACT

A positive-example training data storage section stores training data indicating a feature amount corresponding to a sample image obtained by photographing a sample. A sample image acquiring section acquires a new sample image obtained by newly photographing the sample. A feature amount extracting section generates, on the basis of the new sample image, feature amount data indicating a feature amount corresponding to the new sample image. A storage control section has control, on the basis of the difference between the feature amount indicated by the training data stored in the positive-example training data storage section and the feature amount indicated by the feature amount data, to determine whether to cause the positive-example training data storage section to store the feature amount data as training data, or to discard the feature amount data.

### TECHNICAL FIELD

The present invention relates to a training data selection device, training data selection method, and program.

### BACKGROUND ART

In order to generate a discriminator with high identification accuracy, it is necessary to collect a sufficient number of pieces of training data to be used as positive examples and negative examples, and to cause the discriminator to learn by using these pieces of training data.

### SUMMARY

### Technical Problem

For example, based on an image obtained by photographing a sample, or an image in a region extracted from an image obtained by photographing a sample by using a technique such as an RPN (Region Proposal Network), it is conceivable to generate the above-described training data that indicates the feature amount corresponding to the sample image.

Here, if the image obtained by photographing the sample has blur, unsharpness, or involvement of an object other than the sample, it is not appropriate to cause the discriminator to learn by using training data based on such an image. Moreover, even in the case where the extraction of the region from the image obtained by photographing the sample is not successful, it is not appropriate to cause the discriminator to learn by using training data based on the image of the region.

However, in the prior art, training data inappropriate for learning of the discriminator cannot be excluded from learning targets for the discriminator, as described above.

The present invention has been made in view of the above circumstances, and one of its objects is to provide a training data selection device, training data selection method, and program capable of selecting training data to be used for learning of a discriminator.

### Solution to Problem

In order to solve the above problems, a training data selection device according to the present invention includes a training data storage section that stores training data indicating a feature amount corresponding to a sample image obtained by photographing a sample, a sample image acquiring section that acquires a new sample image obtained by newly photographing the sample, a feature amount data generating section that generates feature amount data indicating a feature amount corresponding to the new sample image, on the basis of the new sample image, and a storage control section that performs control, on the basis of a difference between the feature amount indicated by the training data stored in the training data storage section and the feature amount indicated by the feature amount data, to determine whether to cause the training data storage section to store the feature amount data as the training data or to discard the feature amount data.

In one aspect of the present invention, the storage control section performs control, on the basis of the difference between a feature amount that is among the feature amounts indicated by the plurality of pieces of training data stored in the training data storage section and is closest to the feature amount indicated by the feature amount data, and the feature amount indicated by the feature amount data, to determine whether to cause the training data storage section to store the feature amount data as the training data or to discard the feature amount data.

Further, in one aspect of the present invention, the storage control section performs control to discard the feature amount data in the case where the difference is greater than a given difference.

Further, in one aspect of the present invention, the storage control section performs control to discard the feature amount data in the case where the difference is smaller than a given difference.

Still further, in one aspect of the present invention, a candidate image acquiring section that acquires a plurality of candidate images obtained by photographing the sample, and a reference image selecting section that selects a reference image from among the plurality of candidate images, on the basis of the feature amount corresponding to each of the plurality of candidate images are further provided, and the storage control section causes the training data storage section to store the feature amount data indicating the feature amount corresponding to the reference image as initial training data.

In this aspect, the reference image selecting section may select the reference image from among the plurality of candidate images, on the basis of smallness of the sum of differences between the feature amount of the reference image and respective feature amounts of a predetermined number of other candidate images in the plurality of candidate images.

Further, a training data selection method according to the present invention includes a step of causing a training data storage section to store training data indicating a feature amount corresponding to a sample image obtained by photographing a sample, a step of acquiring a new sample image obtained by newly photographing the sample, a step of generating feature amount data indicating a feature amount corresponding to the new sample image on the basis of the new sample image, and a step of performing control, on the basis of the difference between the feature amount indicated by the training data stored in the training data storage section and the feature amount indicated by the feature amount data, to determine whether to cause the training data storage section to store the feature amount data as the training data or to discard the feature amount data.

Further, a program according to the present invention causes a computer to execute a procedure of causing a training data storage section to store training data indicating a feature amount corresponding to a sample image obtained by photographing a sample, a procedure of acquiring a new sample image obtained by newly photographing the sample, a procedure of generating feature amount data indicating a feature amount corresponding to the new sample image on the basis of the new sample image, and a procedure of performing control, on the basis of the difference between the feature amount indicated by the training data stored in the training data storage section and the feature amount indicated by the feature amount data, to determine whether to cause the training data storage section to store the feature amount data as the training data or to discard the feature amount data.

### BRIEF DESCRIPTION OF DRAWINGS

FIG. 1 is a diagram illustrating an example of a configuration of an information processing device according to an embodiment of the present invention.

FIG. 2 is a diagram illustrating an example of learning of a discriminator according to an embodiment of the present invention.

FIG. 3 is a diagram illustrating an example of identification using a discriminator after learning in an embodiment of the present invention.

FIG. 4A is a diagram illustrating an example of an image.

FIG. 4B is a diagram illustrating an example of an image.

FIG. 5A is a functional block diagram illustrating an example of functions implemented in the information processing device according to an embodiment of the present invention.

FIG. 5B is a functional block diagram illustrating an example of functions implemented in the information processing device according to an embodiment of the present invention.

FIG. 6A is a flow chart illustrating an example of the flow of processing performed in the information processing device according to an embodiment of the present invention.

FIG. 6B is a flow chart illustrating an example of the flow of processing performed in the information processing device according to an embodiment of the present invention.

### Description of Embodiment

An embodiment of the present invention will be described in detail below with reference to the drawings.

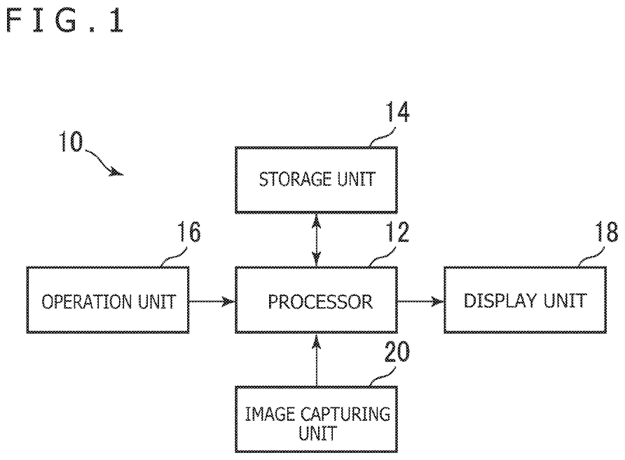

FIG. 1 is a diagram illustrating an example of a configuration of an information processing device 10 according to an embodiment of the present invention. The information processing device 10 according to the present embodiment is a computer such as a game console or a personal computer, for example. As illustrated in FIG. 1, the information processing device 10 according to the present embodiment includes a processor 12, a storage unit 14, an operation unit 16, a display unit 18, and an image capturing unit 20, for example.

The processor 12 is a program-controlled device such as a CPU (Computer Processing Unit) that operates according to a program installed in the information processing device 10, for example.

The storage unit 14 is a storage element, a solid state drive, or the like of a ROM (Read Only Memory) or a RAM (Random Access Memory). The storage unit 14 stores programs and the like executed by the processor 12.

The operation unit 16 is a user interface such as a keyboard, mouse, and controller of a game console, and receives user's operation input and outputs a signal indicating the content of the input to the processor 12.

The display unit 18 is a display device such as a liquid crystal display and displays various images in accordance with instructions from the processor 12.

The image capturing unit 20 is an imaging device such as a digital camera. It is assumed that the image capturing unit 20 according to the present embodiment is a video camera capable of capturing moving images.

Note that the information processing device 10 may include an audio input/output device such as a microphone and a speaker. Further the information processing device 10 may also include a communication interface such as a network board, an optical disk drive for reading optical disks such as DVD (Digital Versatile Disc)-ROMs and Blu-ray (registered trademark) disks, a USB (Universal Serial Bus) port, and the like.

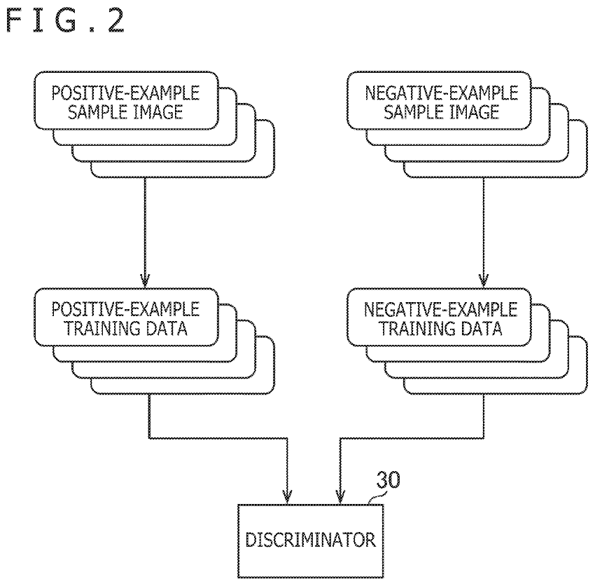

In the present embodiment, as illustrated in FIG. 2, a discriminator 30 (discriminator 30 after learning) such as an SVM (Support Vector Machine) is generated which have learned using a plurality of positive-example training data as positive examples and a plurality of negative-example training data as negative examples. Each of the plurality of positive-example training data is generated based on a sample image representing an object belonging to the positive class in the discriminator 30 (hereinafter referred to as a positive-example sample image), for example. Further, each of the plurality of negative-example training data is generated based on a sample image representing an object belonging to the negative class in the discriminator 30 (hereinafter referred to as a negative-example sample image), for example.

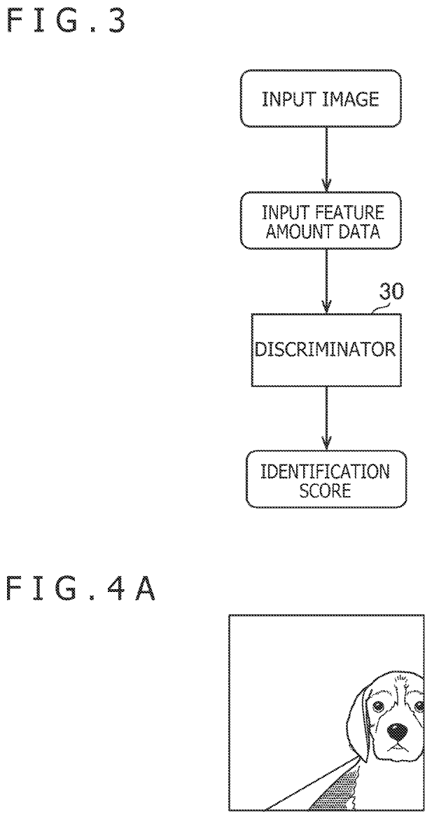

Then, as illustrated in FIG. 3, the discriminator 30 after learning outputs an identification score that indicates the probability that an object contained in the input image belongs to a positive class in the discriminator 30 in response to the input of input feature amount data indicating the feature amount corresponding to the input image.

The information processing device 10 according to the present embodiment stores an RPN (Regional Proposal Network) whose learning is completed in advance, for example. Then, in the present embodiment, the RPN is used to extract a region in which some object is estimated to be imaged from the sample image. This processing can reduce useless calculation and ensure a certain degree of robustness against the environment.

Then, normalization processing such as background removal processing (mask processing) is performed on the image in the extracted region. This processing can reduce the domain gap due to the background and lighting conditions, and as a result, the learning of the discriminator 30 can be completed even from only the data collected under a limited environment.

Further, the information processing device 10 according to the present embodiment stores a CNN (Convolutional Neural Network) for which metric learning has already been performed. This CNN outputs feature amount data indicating the feature amount corresponding to the image in response to the input of the image. This CNN is tuned in advance by metric learning so as to output feature amount data indicating feature amounts close to each other for images containing objects belonging to the positive class. The feature amount indicated by the feature amount data according to the present embodiment is, for example, a vector quantity normalized so that the norm is 1.

In the present embodiment, this CNN is used to generate feature amount data indicating the feature amount corresponding to the image for which normalization processing has been performed. By using a CNN for which metric learning has been performed in advance, feature amounts of samples belonging to one class are aggregated into a compact region regardless of conditions. As a result, the information processing device 10 according to the present embodiment can determine an appropriate identification boundary in the discriminator 30 even from a small number of samples.

In the present embodiment, by inputting an image obtained by normalizing the image in the region extracted from a positive-example sample image by an RPN into a CNN that has already undergone metric learning, feature amount data indicating the feature amount corresponding to the positive-example sample image is generated. The feature amount data generated from the positive-example sample image in such a way corresponds to the positive-example training data illustrated in FIG. 2.

Further, in the present embodiment, by inputting an image obtained by normalizing the image in the region extracted by an RPN from a negative-example sample image to a CNN that has already undergone metric learning, feature amount data that indicates the feature amount corresponding to the negative-example sample image is generated. The feature amount data generated from the negative-example sample image in such a way corresponds to the negative-example training data illustrated in FIG. 2

In the present embodiment, even for the input image that is the target of estimating the object which is imaged, similarly, by means of extraction of the region, normalization processing, and generation of feature amount data using a CNN which has undergone metric learning, described above, input feature amount data corresponding to the input image is generated. Then, by inputting the input feature amount data generated in such a way to the discriminator 30 having learned, the discriminator 30 after learning output the identification score indicating the probability that the object in the input image belongs to the positive class.

In order to generate the discriminator 30 with high identification accuracy, it is necessary to collect a sufficient number of pieces of training data to be used as positive examples and negative examples, and to cause the discriminator 30 to learn by using the training data.

Here, for example, it is conceivable that the above-described training data indicating the feature amount corresponding to the sample image is generated based on an image captured by photographing the sample, or an image in a region extracted from an image captured by photographing the sample using a technique such as RPN.

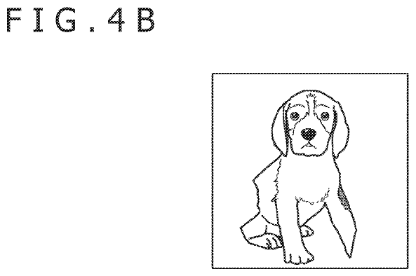

Here, if the captured image of the sample has blur, unsharpness, or involvement of an object other than the sample, it is not appropriate to allow the discriminator 30 to learn by using training data based on such an image. Also, as in the image illustrated in FIG. 4A, the extraction of a region using the RPN from the captured image of the sample may be unsuccessful. Further, as in the image illustrated in FIG. 4B, the background removal processing may be unsuccessful. Also in these cases, it is not appropriate to allow the discriminator 30 to learn by training data based on such images.

Based on the above points, in the present embodiment, the training data to be used for learning of the discriminator 30 is made selectable as follows.

Functions implemented in the information processing device 10 according to the present embodiment and processes executed in the information processing device 10 according to the present embodiment will be described below.

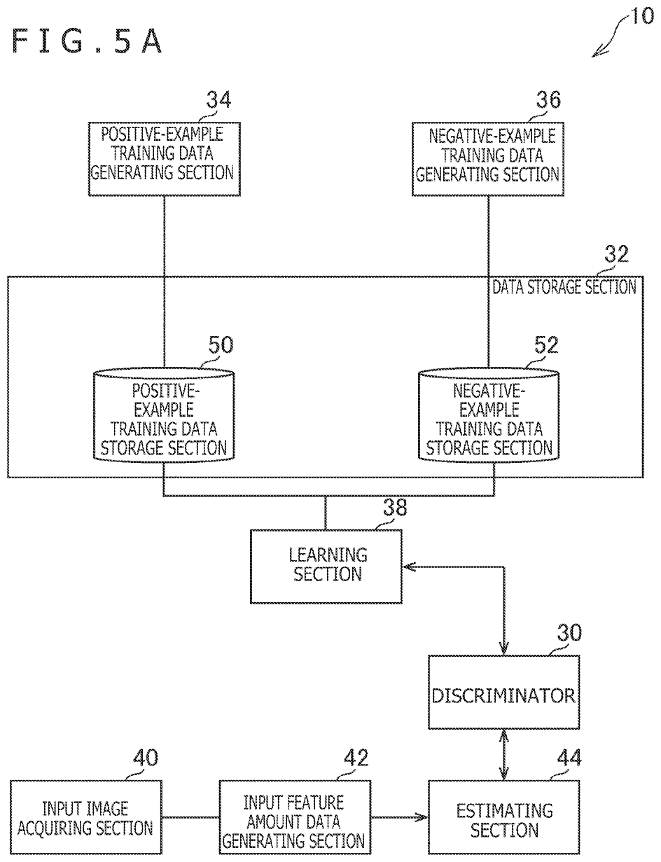

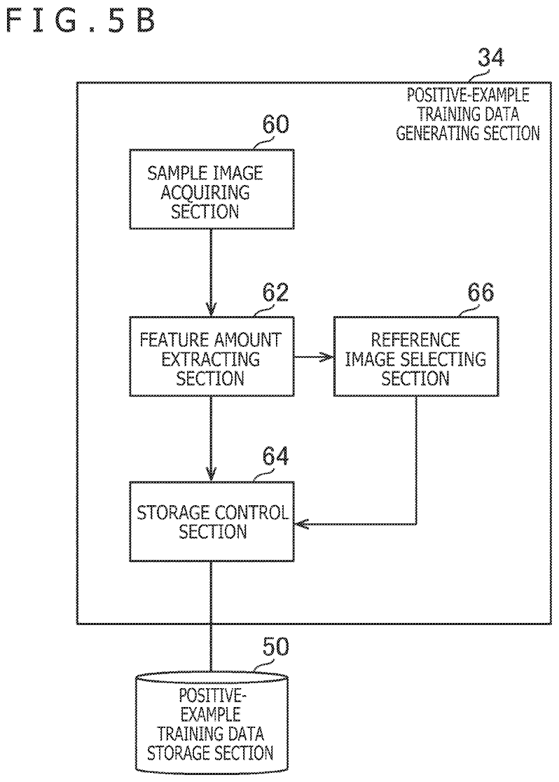

FIGS. 5A and 5B are functional block diagrams illustrating an example of functions implemented in the information processing device 10 according to the present embodiment. Note that all the functions illustrated in FIGS. 5A and 5B do not need to be implemented in the information processing device 10 according to the present embodiment and also functions other than the functions illustrated in FIGS. 5A and 5B may be implemented.

As illustrated in FIG. 5A, the information processing device 10 according to the present embodiment functionally includes the discriminator 30, a data storage section 32, a positive-example training data generating section 34, a negative-example training data generating section 36, a learning section 38, an input image acquiring section 40, an input feature amount data generating section 42, and an estimating section 44, for example.

Then, the data storage section 32 includes a positive-example training data storage section 50 and a negative-example training data storage section 52.

FIG. 5B illustrates details of the functions implemented in the positive-example training data generating section 34 illustrated in FIG. 5A. As illustrated in FIG. 5B, the positive-example training data generating section 34 functionally includes a sample image acquiring section 60, a feature amount extracting section 62, a storage control section 64, and a reference image selecting section 66, for example.

The positive-example training data storage section 50 and the negative-example training data storage section 52 are implemented mainly in the storage unit 14. The discriminator 30 is implemented mainly in the processor 12 and the storage unit 14. The input image acquiring section 40 and the sample image acquiring section 60 are implemented mainly in the processor 12 and the image capturing unit 20. The negative-example training data generating section 36, the learning section 38, the input feature amount data generating section 42, the estimating section 44, the feature amount extracting section 62, the storage control section 64, and the reference image selecting section 66 are implemented mainly in the processor 12.

In the present embodiment, the discriminator 30 is a machine learning model such as an SVM that determines whether or not an object in an input image belongs to a positive class, for example, as described with reference to FIGS. 2 and 3.

In the present embodiment, the positive-example training data generating section 34 generates, for example, the above-described positive-example training data by which the discriminator 30 is made to learn as positive examples. The positive-example training data generating section 34 causes the positive-example training data storage section 50 to store the generated positive-example training data.

For example, for each of a plurality of positive-example sample images captured by the image capturing unit 20, the positive-example training data generating section 34 generates positive-example feature amount data which is indicating a feature amount corresponding to the positive-example sample image. Each of these positive-example sample images represents an object belonging to the positive class in the discriminator 30. Here, extraction of the region, normalization processing, and generation of feature amount data using a CNN for which metric learning has already been executed, described above, may be performed to generate positive-example feature amount data corresponding to the positive-example sample image.

In the present embodiment, the negative-example training data generating section 36 generates the above-described negative-example training data that is used for the learning of the discriminator 30 as negative examples, for example. The negative-example training data generating section 36 causes the negative-example training data storage section 52 to store the generated negative-example training data.

In the present embodiment, for example, negative-example sample images which are images captured by the image capturing unit 20 or images collected from the Web, are accumulated in advance in the information processing device 10. Each of these negative-example sample images represents an object belonging to the negative class in the discriminator 30. Then, the negative-example training data generating section 36 generates negative-example feature amount data which is indicating the feature amount corresponding to the negative-example sample image, for each of these negative-example sample images. Here, extraction of the region, normalization processing, and generation of feature amount data using a CNN for which metric learning has already been executed, described above, may be performed to generate negative-example feature amount data corresponding to the negative-example sample image.

In the present embodiment, for example, the learning section 38 generates the discriminator 30 having been made to learn (discriminator 30 having learned), with the positive-example training data stored in the positive-example training data storage section 50 regarded as positive examples, and the negative-example training data stored in the negative-example training data storage section 52 regarded as negative examples, for example.

In the present embodiment, the input image acquiring section 40 acquires an input image captured by the image capturing unit 20 and used as an estimation target for the object in the image, for example.

In the present embodiment, for example, the input feature amount data generating section 42 generates input feature amount data indicating the feature amount corresponding to the input image as described above.

In the present embodiment, for example, the estimating section 44 inputs the input feature amount data to the discriminator 30 to estimate whether or not the object in the input image belongs to the positive class in the discriminator 30. Here, the estimating section 44 may identify a value of the identification score output from the discriminator 30 according to the input of the input feature amount data, for example.

In the present embodiment, for example, photographing and acquiring an input image, generating input feature amount data, and estimating whether or not an object in the input image belongs to a positive class are repeatedly executed at a predetermined frame rate. In such a way, in the present embodiment, it is estimated for each frame whether or not the object in the input image captured in the frame belongs to the positive class. Therefore, according to the present embodiment, high-speed object detection can be realized. Further, according to the present embodiment, the discriminator 30 can learn with a small amount of data prepared by the user, and thus, unlike the prior art, it is not necessary to prepare a large amount of labeled data for learning of the discriminator 30.

The function of the positive-example training data generating section 34 will be further described below. As described above, the positive-example training data generating section 34 functionally includes, for example, the sample image acquiring section 60, the feature amount extracting section 62, the storage control section 64, and the reference image selecting section 66.

In the present embodiment, the sample image acquiring section 60 repeatedly acquires sample images which are captured images of the samples, for example. The sample image acquiring section 60 repeatedly acquires positive-example sample images in which objects belonging to the positive class are present, for example. For example, the user captures moving images of the sample from various angles while moving the image capturing unit 20. The sample image acquiring section 60 acquires frame images included in the moving image captured in such a way.

In the present embodiment, for example, the feature amount extracting section 62 generates feature amount data indicating the feature amount corresponding to the sample image on the basis of the sample image. Here, the sample image is subjected to extraction of the region, normalization processing, and feature amount data generation using a CNN that has undergone metric learning, described above, so that the feature amount data corresponding to the sample image may be generated.

As described above, in the case where a positive-example sample image is acquired, the feature amount extracting section 62 generates positive-example feature amount data indicating the feature amount corresponding to the positive-example sample image, for example.

In the present embodiment, for example, the storage control section 64 performs control to determine whether to cause the positive-example training data storage section 50 to store new positive-example feature amount data generated based on the new positive-example sample image and corresponding to a new positive-example sample image as positive-example training data or to discard the positive-example feature amount data. In the present embodiment, the storage control section 64 identifies, for example, a difference between the feature amount indicated by the positive-example training data stored in the positive-example training data storage section 50, and the new positive-example feature amount data generated based on a new sample image and corresponding to the sample image. Here, a difference between the feature amount closest to the feature amount indicated by the feature amount data corresponding to the new sample image among the feature amounts indicated by the plurality of training data, respectively, stored in the positive-example training data storage section 50, and the feature amount indicated by the feature amount data may be identified. Then, based on the identified difference, the storage control section 64 performs control to determine whether to cause the positive-example training data storage section 50 to store the positive-example feature amount data as positive-example training data, or to discard the positive-example feature amount data.

In the present embodiment, for example, the reference image selecting section 66 selects a reference image from among the plurality of candidate images on the basis of the feature amount corresponding to each of the plurality of candidate images obtained by photographing the sample.

In the present embodiment, for example, a predetermined number (for example, 50) of candidate images are acquired by the sample image acquiring section 60. Here, for example, a candidate image in which an object belonging to the positive class in the discriminator 30 is imaged is acquired. Then, the feature amount extracting section 62 generates positive-example feature amount data corresponding to the candidate image for each of these candidate images.

Hereinafter, for example, these 50 candidate images are represented as candidate images P(1) to P(50), and the feature amount indicated by positive-example feature amount data generated based on the candidate images P(n) (n=1 to 50) is represented as C(n).

Then, for each of these candidate images, the feature amount extracting section 62 identifies a predetermined number (for example, N) of other candidate images in descending order of approximation of the feature amount indicated by the corresponding positive-example feature amount data. Then, the feature amount extracting section 62 identifies the sum of differences between the feature amounts corresponding to the identified other candidate images and the feature amount of the candidate image (hereinafter referred to as the sum of the neighborhood feature amount differences).

For example, for the candidate image P(1), N feature amounts are selected in ascending order of difference from C(1) from among the feature amounts C(2) to C(50). These feature amounts are represented as D(1) to D(N). In this case, for example, (distance between C(1) and D(1))+(distance between C(1) and D(2))+ . . . +(distance between C(1) and D(N)) is identified as the sum of the neighborhood feature amount differences for candidate image P(1). In a similar way, sums of the neighborhood feature amount differences are identified also for the candidate images P(2) to P(50). Then, the reference image selecting section 66 selects a candidate image whose corresponding sum of the neighborhood feature amount differences is smallest as the reference image.

In such a manner, the reference image selecting section 66 may select a reference image from among a plurality of candidate images on the basis of the smallness of the sum of the feature amount differences from the respective predetermined number of other candidate images.

Then, the storage control section 64 causes the positive-example training data storage section 50 to store the positive-example feature amount data indicating the feature amount corresponding to the reference image as an initial positive-example training data.

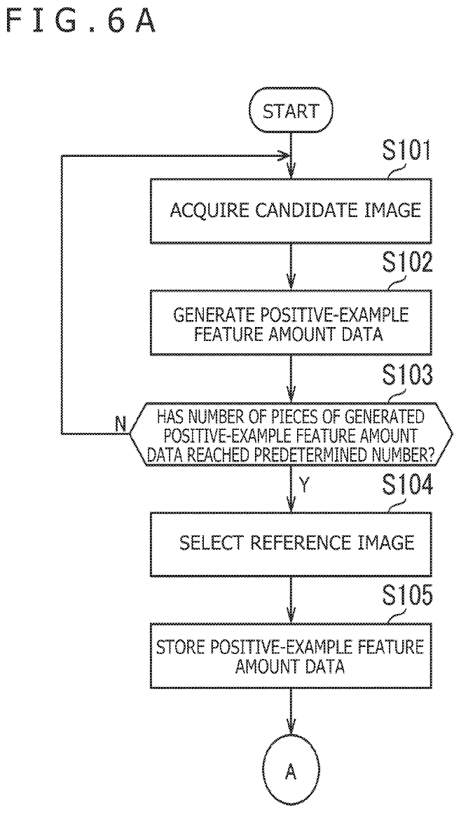

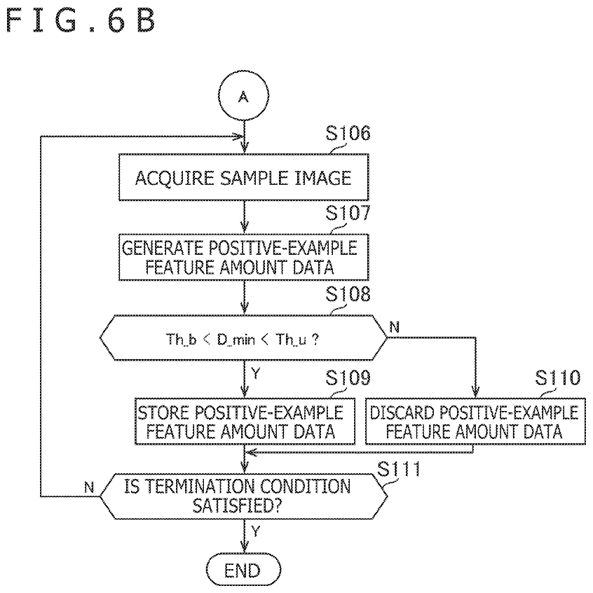

Here, a flow example of selection processing of feature amount data executed in the information processing device 10 according to the present embodiment will be described with reference to flowcharts illustrated in FIGS. 6A and 6B. It should be noted that in the processing example illustrated below, it is assumed that the user captures moving images of a sample from various angles while moving the image capturing unit 20. Then, the image capturing unit 20 generates frame images obtained by photographing the sample at a predetermined frame rate. Further, it is also assumed that no positive-example training data is stored in the positive-example training data storage section 50.

First, the sample image acquiring section 60 obtains a candidate image which is the latest image of a sample of an object belonging to the positive class captured by the image capturing unit 20 (S101).

Then, based on the candidate image acquired in the process indicated in S101, the feature amount extracting section 62 generates positive-example feature amount data indicating the feature amount corresponding to the candidate image (S102).

Then, the feature amount extracting section 62 checks whether or not the number of pieces of positive-example feature amount data generated in the process indicated in S102 has reached a predetermined number (for example, 50) (S103).

In the case where the number of pieces of generated feature amount data has not reached the predetermined number (S103: N), the processing returns to S101.

In the case where the number of pieces of generated positive-example feature amount data has reached the predetermined number (S103: Y), the feature amount extracting section 62 follows the predetermined criteria as described above, and select one of the predetermined number of candidate images obtained in the process indicated in S101 as a reference image (S104).

Then, the storage control section 64 causes the positive-example training data storage section 50 to store the positive-example feature amount data generated in the process exhibited in S102 as positive-example training data on the basis of the reference image selected in the process exhibited in S104 (S105).

While the processes indicated in S101 to S105 are being executed, the image capturing unit 20 desirably performs image capturing in a relatively narrow range in front of the sample. Moreover, the user is desirably notified of the completion of the process exhibited in S105 by means of display on the display unit 18, voice output, or the like.

When the process exhibited in 5105 is completed, the sample image acquiring section 60 acquires a sample image which is the latest captured image of the sample (S106).

Then, based on the sample image acquired in the process indicated in S106, the feature amount extracting section 62 generates positive-example feature amount data indicating the feature amount corresponding to the sample image (S107).

After this, the storage control section 64 determines whether or not the feature amount data generated by the process indicated in S107 satisfies a predetermined condition (S108).

In the process indicated in S108, for example, training data from the positive-example training data stored in the positive-example training data storage section 50, whose indicated feature amount is closest to the feature amount indicated by the positive-example feature amount data generated in the process exhibited in S107 is selected. Then, a value D_min indicating the cosine distance between the feature amount indicated by the selected positive-example training data and the feature amount indicated by the positive-example feature amount data generated in the process indicated in S107 is identified.

Then, in the case where the value D_min indicating the cosine distance is larger than the predetermined first threshold Th b and smaller than the predetermined second threshold Th u, it is determined that the feature amount data generated in the process exhibited in S107 satisfies the predetermined condition. Otherwise, it is determined that the feature amount data generated in the process indicated in S107 does not satisfy the predetermined condition.

In the case where it is determined that the positive-example feature amount data generated in the process indicated in S107 satisfies the predetermined condition (S108: Y), the storage control section 64 causes the positive-example training data storage section 50 to store the positive-example feature amount data generated in the process indicated in S107 as positive-example training data (S109).

In the case where it is determined that the positive-example feature amount data generated in the process exhibited in S107 does not satisfy the predetermined condition (S108: N), the storage control section 64 discards the positive-example feature amount data generated in the process exhibited in S107 (S110).

Then, the storage control section 64 confirms whether or not a predetermined termination condition (for example, the number of pieces of positive-example training data stored in the positive-example training data storage section 50 has reached a predetermined number or more) is satisfied (S111).

In the case where the predetermined termination condition is not satisfied (S111: N), the processing returns to S106.

In the case where the predetermined termination condition is satisfied (S111: Y), the processing illustrated in this processing example is terminated.

The learning section 38 causes the discriminator 30 to learn by means of the positive-example training data finally stored in the positive-example training data storage section 50 and the negative-example training data finally stored in the negative-example training data storage section 52 according to the processing exhibited in FIGS. 6A and 6B.

In the processing illustrated in this processing example, the value of the threshold TH_b and the value of the threshold TH_u may be dynamic values determined according to the difference between the feature amount of the candidate image and the feature amounts of the other candidate images when the reference image is selected. For example, for each candidate image, the feature amount extracting section 62 may identify a predetermined number (for example, M (M<N)) of other candidate images in descending order of approximation of the feature amount indicated by the corresponding positive-example feature amount data. Then, the feature amount extracting section 62 may identify, for each candidate image, the difference between the feature amounts corresponding to the identified M number of other candidate images and the feature amount of the candidate image. Then, the feature amount extracting section 62 may determine a value that is half the average value of the identified differences as the value of the threshold TH_b.

Moreover, the positive-example feature amount data corresponding to the sample image that is determined by tracking to have no spatial continuity with the immediately preceding image capturing may be discarded.

In the present embodiment, as described above, control to determine whether to cause the positive-example training data storage section 50 to store new feature amount data as positive-example training data or to discard the data is performed based on the feature amount indicated by the positive-example training data stored in the positive-example training data storage section 50. Thus, according to the present embodiment, training data to be used for learning of the discriminator 30 can be selected.

Further, in the present embodiment, the storage control section 64 may have control such that the new feature amount data is discarded in the case where the difference between the feature amount indicated by the positive-example training data stored in the positive-example training data storage section 50 and the feature amount indicated by the new feature amount data is smaller than a predetermined value. For example, as described above, the storage control section 64 may perform control such that new feature amount data is discarded in the case where the above value D_min is smaller than the above first threshold value Th_b. By doing this, for example, the positive-example training data indicating similar feature amount can be prevented from being redundantly stored in the positive-example training data storage section 50.

Further, in the present embodiment, the storage control section 64 may have control such that the new feature amount data is discarded in the case where the difference between the feature amount indicated by the positive-example training data stored in the positive-example training data storage section 50 and the feature amount indicated by the new feature amount data is greater than a predetermined value. For example, as described above, the storage control section 64 may perform control such that new feature amount data is discarded in the case where the value D_min is greater than the above second threshold Th_u. By doing this, for example, control can be performed so that feature amount data based on a captured sample image is discarded when blur, unsharpness, or involvement of an object other than the sample occurs.

It should be noted that the present invention is not limited to the above-described embodiment.

For example, the distance used for determination in the process illustrated in S108 does not need to be the cosine distance as described above. For example, a value indicating the Euclidean distance between the feature amount indicated by the selected positive-example training data and the feature amount indicated by the feature amount data generated in the process exhibited in S107 may be identified as the value D_min. Then, in the case where the value D_min indicating the Euclidean distance is larger than the predetermined first threshold Th_b and smaller than the predetermined second threshold Th_u, it may be determined that the feature amount data generated in the process indicated in S107 satisfies the predetermined condition. Then, otherwise, it may be determined that the feature amount data generated in the process indicated in S107 does not satisfy the predetermined condition.

Also, for example, the discriminator 30 may be an SVM with any kernel. Further, the discriminator 30 may be a discriminator using a technique such as K-nearest neighbor algorithm, logistic regression, or a boosting technique such as AdaBoost. Also, a neural network, naive Bayes classifier, random forest, decision tree, or the like may be implemented in the discriminator 30. Further, the discriminator 30 does not need to have two classes of the classification class and may be one capable of classification into three or more classes (that is, one having a plurality of positive classes different from one another).

Further, the discriminator 30 may output a binary identification score indicating whether or not the object in the input image belongs to the positive class.

Further, a plurality of regions may be extracted from the input image, and whether or not the object in the image of the region belongs to the positive class may be estimated by the estimating section 44 for each region.

In addition, the above-described method can also be used when negative-example training data is generated based on negative-example sample image obtained by photographing a negative-example sample, and a plurality of pieces of generated negative-example training data are accumulated in the negative-example training data storage section 52. In this case, control is performed to determine whether to cause the negative-example training data storage section 52 to store the negative-example feature amount data generated based on the negative-example sample image as the negative-example training data or discard the negative-example feature amount data.

In addition, the specific character strings and numerical values described above and the specific character strings and numerical values in the drawings are examples, and the present invention is not limited to these character strings and numerical values.

1. A training data selection device comprising:
a training data storage section that stores training data indicating a feature amount corresponding to a sample image obtained by photographing a sample;
a sample image acquiring section that acquires a new sample image obtained by newly photographing the sample;
a feature amount data generating section that generates feature amount data indicating a feature amount corresponding to the new sample image, on a basis of the new sample image; and
a storage control section that performs control, on a basis of a difference between the feature amount indicated by the training data stored in the training data storage section and the feature amount indicated by the feature amount data, to determine whether to cause the training data storage section to store the feature amount data as the training data or to discard the feature amount data.

2. The training data selection device according to claim 1, wherein the storage control section performs control, on a basis of a difference between a feature amount that is among feature amounts indicated by the plurality of pieces of training data stored in the training data storage section and is closest to the feature amount indicated by the feature amount data, and the feature amount indicated by the feature amount data, to determine whether to cause the training data storage section to store the feature amount data as the training data or to discard the feature amount data.

3. The training data selection device according to claim 1, wherein the storage control section performs control to discard the feature amount data when the difference is greater than a given difference.

4. The training data selection device according to claim 1, wherein the storage control section performs control to discard the feature amount data when the difference is smaller than a given difference.

5. The training data selection device according to claim 1, further comprising:
a candidate image acquiring section that acquires a plurality of candidate images obtained by photographing the sample; and
a reference image selecting section that selects a reference image from among the plurality of candidate images, on a basis of a feature amount corresponding to each of the plurality of candidate images, wherein
the storage control section causes the training data storage section to store the feature amount data indicating a feature amount corresponding to the reference image as initial training data.

6. The training data selection device according to claim 5, wherein the reference image selecting section selects the reference image from among the plurality of candidate images, on a basis of smallness of a sum of differences between the feature amount of the reference image and respective feature amounts of a predetermined number of other candidate images in the plurality of candidate images.

7. A training data selection method comprising:
causing a training data storage section to store training data indicating a feature amount corresponding to a sample image obtained by photographing a sample;
acquiring a new sample image obtained by newly photographing the sample;
generating feature amount data indicating a feature amount corresponding to the new sample image, on a basis of the new sample image; and
performing control, on a basis of a difference between the feature amount indicated by the training data stored in the training data storage section and the feature amount indicated by the feature amount data, to determine whether to cause the training data storage section to store the feature amount data as the training data or to discard the feature amount data.

8. A non-transitory, computer readable storage medium containing a computer program, which when executed by a computer, causes the computer to perform a method by carrying out actions, comprising:
causing a training data storage section to store training data indicating a feature amount corresponding to a sample image obtained by photographing a sample;
acquiring a new sample image obtained by newly photographing the sample;
generating feature amount data indicating a feature amount corresponding to the new sample image, on a basis of the new sample image; and
performing control, on a basis of a difference between the feature amount indicated by the training data stored in the training data storage section and the feature amount indicated by the feature amount data, to determine whether to cause the training data storage section to store the feature amount data as the training data or to discard the feature amount data.
